(19) United States
(12) Patent Application Publication
(10) Pub. No.: US 2016/0372270 A1
(43) Pub. Date: Dec. 22, 2016

(54) PHOTOELECTROCHEMICAL REACTION DEVICE

(71) Applicant: KABUSHIKI KAISHA TOSHIBA, Minato-ku (JP)

(72) Inventors: Yuki KUDO, Yokohama (JP); Satoshi MIKOSHIBA, Yamato (JP); Akihiko ONO, Kita (JP); Jun TAMURA, Yokohama (JP); Eishi TSUTSUMI, Kawasaki (JP); Ryota KITAGAWA, Setagaya (JP); Yoshitsune SUGANO, Kawasaki (JP)

(73) Assignee: KABUSHIKI KAISHA TOSHIBA, Minato-ku (JP)

(21) Appl. No.: 15/252,932

(22) Filed: Aug. 31, 2016

Related U.S. Application Data
(63) Continuation of application No. PCT/JP2015/001232, filed on Mar. 6, 2015.

(30) Foreign Application Priority Data
May 20, 2014 (JP) 2014-104620

(51) Int. Cl. H01G 9/20; C25B 1/00; C25B 13/08; C25B 11/04; C25B 1/04; C25B 3/04

(52) U.S. Cl. CPC H01G 9/2013; C25B 1/04; C25B 3/04; C25B 13/08; C25B 11/0405; C25B 1/003

(57) ABSTRACT

A photoelectrochemical reaction device in an embodiment includes: first and second photovoltaic cells each including a first electrode, a second electrode, and a photovoltaic layer; first and second reaction electrode pairs each including a third electrode and a fourth electrode; and an electrolytic bath storing a first electrolytic solution in which the third electrodes are immersed and a second electrolytic solution in which the fourth electrodes are immersed. One of the third and fourth electrodes causes an oxidation reaction, and the other of the third and fourth electrodes causes a reduction reaction. The first photovoltaic cell is electrically connected to the first reaction electrode pair, and the second photovoltaic cell is electrically connected to the second reaction electrode pair.

### CROSS-REFERENCE TO RELATED APPLICATIONS

This application is a continuation of prior International Application No. PCT/JP2015/001232 filed on Mar. 6, 2015, which is based upon and claims the benefit of priority from Japanese Patent Application No. 2014-104620 filed on May 20, 2014; the entire contents of all of which are incorporated herein by reference.

### TECHNICAL FIELD

Embodiments described herein generally relate to a photoelectrochemical reaction device.

### BACKGROUND ART

In recent years, there has been concern about the depletion of fossil fuel such as petroleum and coal, and renewable energy that can be sustainably utilized is increasingly expected. As one of the renewable energies, a solar cell and heat power generation which use sunlight are under development. The solar cell has problems that it requires cost for storage batteries used when the generated power (electricity) is stored and a loss occurs at the time of the power storage. A technique of directly converting the sunlight to a chemical substance (chemical energy) such as hydrogen (H₂), carbon monoxide (CO), methanol (CH₃OH), or formic acid (HCOOH) instead of converting the sunlight to electricity has been drawing attention. Storing the chemical substance converted from the sunlight in a cylinder or a tank has advantages that it requires less cost for storing the energy and further the storage loss is smaller, as compared with storing electricity converted from the sunlight in the storage battery.

As a device that converts sunlight energy to chemical energy, there are known photoelectrochemical reaction devices in which a photovoltaic unit and an electrolytic unit are integrated together. The photoelectrochemical reaction devices are roughly classified into a cell-integrated type device in which a photovoltaic cell is not immersed in an electrolytic solution but integrally arranged on an electrolytic bath, and a cell-immersed type device in which a photovoltaic cell is immersed in an electrolytic solution. In the photoelectrochemical reaction device of the cell-integrated type, when a plurality of photovoltaic cells are used for enhancing the electromotive force, it is conceivable to connect the plurality of photovoltaic cells connected in parallel, to electrodes (anode and cathode). In this case, when part of the plural photovoltaic cells becomes shaded due to could or a failure occurs in part of the plural photovoltaic cells, not only electromotive force decreases correspondingly to the portion of the failed cell but also the conversion efficiency of the whole device decreases by the effect of the cell decreased in parallel resistance due to the failure.

### BRIEF DESCRIPTION OF THE DRAWINGS

FIG. 1 is a plan view illustrating a photoelectrochemical reaction device according to a first embodiment.

FIG. 2 is a cross-sectional view taken along a line A-A in FIG. 1.

FIG. 3 is a cross-sectional view taken along a line B-B in FIG. 1.

FIG. 4 is a view illustrating an electrical connection state of the photoelectrochemical reaction device illustrated in FIG. 1.

FIG. 5 is a view illustrating an electrical connection state of another example of the photoelectrochemical reaction device according to the first embodiment.

FIG. 6 is a cross-sectional view illustrating a first configuration example of a photovoltaic cell in the photoelectrochemical reaction device of the embodiment.

FIG. 7 is a cross-sectional view illustrating a second configuration example of a photovoltaic cell in the photoelectrochemical reaction device of the embodiment.

FIG. 8 is a cross-sectional view illustrating a third electrode in the photoelectrochemical reaction device of the embodiment.

FIG. 9 is a cross-sectional view illustrating a fourth electrode in the photoelectrochemical reaction device of the embodiment.

FIG. 10 is a plan view illustrating a photoelectrochemical reaction device according to a second embodiment.

FIG. 11 is a view illustrating an electrical connection state of a plurality of photovoltaic cells in a photovoltaic module of the photoelectrochemical reaction device illustrated in FIG. 10.

FIG. 12 is a view illustrating an electrical connection state between a plurality of photovoltaic modules in the photoelectrochemical reaction device illustrated in FIG. 10 and reaction electrode pairs.

FIG. 13 is a plan view illustrating a photoelectrochemical reaction device according to a third embodiment.

FIG. 14 is a cross-sectional view taken along a line A-A in FIG. 13.

FIG. 15 is a view illustrating an electrical connection state of the photoelectrochemical reaction device illustrated in FIG. 12.

FIG. 16 is a view illustrating an electrical connection state of another example of the photoelectrochemical reaction device according to the third embodiment.

FIG. 17 is a top perspective view illustrating a photoelectrochemical reaction device according to a fourth embodiment.

FIG. 18 is a cross-sectional view taken along a line A-A in FIG. 17.

FIG. 19 is a cross-sectional view taken along a line B-B in FIG. 17.

FIG. 20 is a view illustrating an electrical connection state of the photoelectrochemical reaction device illustrated in FIG. 17.

FIG. 21 is a cross-sectional view illustrating a first modification example of the photoelectrochemical reaction device according to the fourth embodiment.

FIG. 22 is a top perspective view illustrating a second modification example of the photoelectrochemical reaction device according to the fourth embodiment.

FIG. 23 is a cross-sectional view taken along a line B-B in FIG. 22.

FIG. 24 is a top perspective view illustrating a photoelectrochemical reaction device according to a fifth embodiment.

FIG. 25 is a cross-sectional view taken along a line A-A in FIG. 24.

FIG. 26 is a cross-sectional view taken along a line B-B in FIG. 24.

FIG. 27 is a cross-sectional view illustrating a modification example of the photoelectrochemical reaction device according to the fifth embodiment.

### DETAILED DESCRIPTION

According to one embodiment, there is provided a photoelectrochemical reaction device including: a first photovoltaic cell including a first electrode, a second electrode, and a photovoltaic layer provided between the first electrode and the second electrode; a second photovoltaic cell including a first electrode, a second electrode, and a photovoltaic layer provided between the first electrode and the second electrode; a reaction electrode pair including at least one third electrode and two divided fourth electrodes, and one of the third and fourth electrodes causing an oxidation reaction, and the other of the third and fourth electrodes causing a reduction reaction; a first connecting member electrically connecting the first electrodes of the first and second photovoltaic cells to the third electrode of the reaction electrode pair; a second connecting member electrically connecting the second electrode of the first photovoltaic cell to one of the two fourth electrodes of the reaction electrode pair; a third connecting member electrically connecting the second electrode of the second photovoltaic cell to the other of the two fourth electrodes of the reaction electrode pair; and an electrolytic bath storing a first electrolytic solution in which at least the third electrode is immersed and a second electrolytic solution in which at least the fourth electrodes are immersed.

Hereinafter, photoelectrochemical reaction devices of embodiments will be described with reference to the drawings.

### First Embodiment

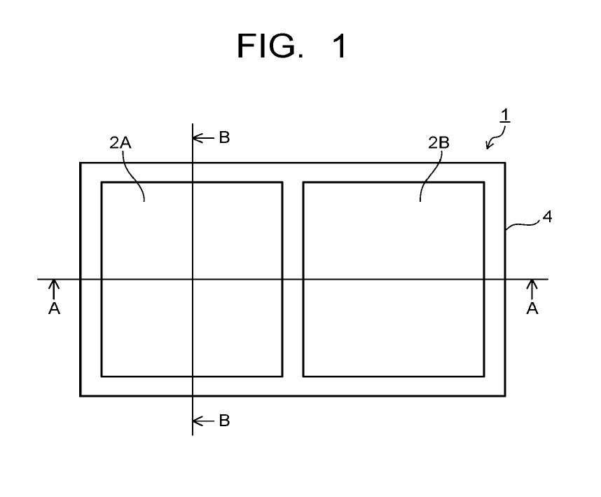

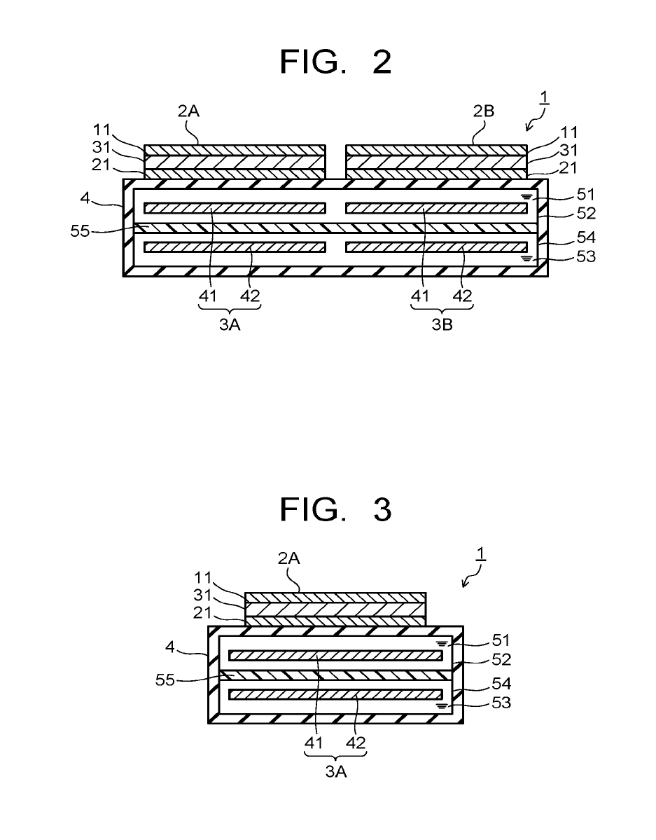

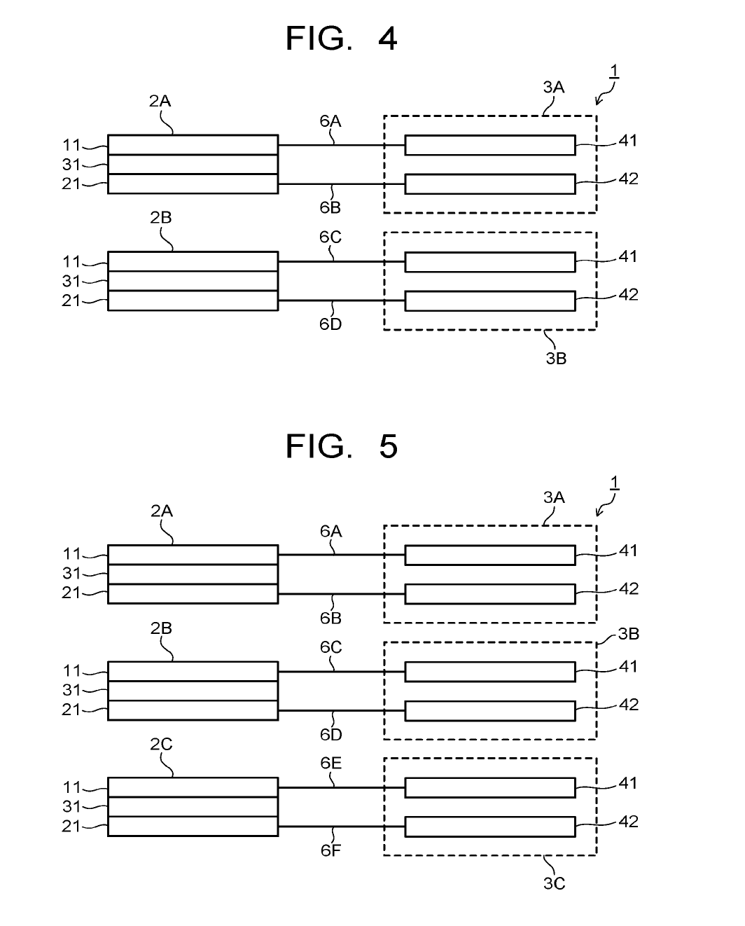

FIG. 1 to FIG. 4 are views illustrating a photoelectrochemical reaction device according to a first embodiment. FIG. 1 is a plan view of the photoelectrochemical reaction device, FIG. 2 is a cross-sectional view taken along a line A-A in FIG. 1, FIG. 3 is a cross-sectional view taken along a line B-B in FIG. 1, and FIG. 4 is a view illustrating an electrical connection state of FIG. 1. The photoelectrochemical reaction device 1 of the first embodiment includes a first photovoltaic cell 2A, a second photovoltaic cell 2B, a first reaction electrode pair 3A, a second reaction electrode pair 3B, and an electrolytic bath 4. Each of the first and second photovoltaic cells 2A, 2B includes a first electrode 11, a second electrode 21, and an photovoltaic layer 31 which is provided between the first and second electrodes 11 and 21 and performs charge separation by light energy. The first and second photovoltaic cells 2A, 2B are arranged outside the electrolytic bath 4.

Each of the first and second reaction electrode pairs 3A, 3B includes a third electrode 41 and a fourth electrode 42 arranged to be opposed to the third electrode 41. The first and second reaction electrode pairs 3A, 3B are arranged inside the electrolytic bath 4. The electrolytic bath 4 includes a first storage part 52 storing a first electrolytic solution 51 in which the third electrodes 41 are immersed, a second storage part 54 storing a second electrolytic solution 53 in which the fourth electrodes 42 are immersed, and an ion migration layer (an ion migration layer also serving as a separation wall) 55 allowing ions to migrate while separating the first electrolytic solution 51 and the second electrolytic solution 53. One of the third electrode 41 and the fourth electrode 42 causes an oxidation reaction and the other of the third electrode 41 and the fourth electrode 42 causes a reduction reaction. Specifically, a photoelectromotive force generated by radiating the sunlight or the like to the photovoltaic cells 2A, 2B causes the oxidation and reduction reactions by the reaction electrode pairs 3A, 3B.

As illustrated in FIG. 4, the first electrode 11 of the first photovoltaic cell 2A is electrically connected to the third electrode 41 of the first reaction electrode pair 3A via a connecting member 6A, and the second electrode 21 of the first photovoltaic cell 2A is electrically connected to the fourth electrode 42 of the first reaction electrode pair 3A via a connecting member 6B. Similarly, the first electrode 11 of the second photovoltaic cell 2B is electrically connected to the third electrode 41 of the second reaction electrode pair 3B via a connecting member 6C, and the second electrode 21 of the second photovoltaic cell 2B is electrically connected to the fourth electrode 42 of the second reaction electrode pair 3B via a connecting member 6D. Electrical connection of the photovoltaic cell 2 and the reaction electrode pair 3 as a set prevents a failure, even when occurring in one photovoltaic cell 2, from adversely affecting the other combination of the photovoltaic cell 2 and the reaction electrode pair 3. The conversion efficiency from light energy to chemical energy by the photoelectrochemical reaction device 1 can be maintained.

Though the photoelectrochemical reaction device 1 having a combination of the first photovoltaic cell 2A and the first reaction electrode pair 3A and a combination of the second photovoltaic cell 2B and the second reaction electrode pair 3B is illustrated in FIG. 1 to FIG. 4, the number of combinations of the photovoltaic cell 2 and the reaction electrode pair 3 is not limited to this. The photoelectrochemical reaction device 1 may have three sets or more of the combination of the photovoltaic cell 2 and the reaction electrode pair 3. Also in this case, one photovoltaic cell 2 and one reaction electrode pair 3 are combined as a set and electrically connected. FIG. 5 illustrates a photoelectrochemical reaction device 1 including three sets of the combination of the photovoltaic cell 2 and the reaction electrode pair 3. The photoelectrochemical reaction device 1 illustrated in FIG. 5 further includes a combination of a third photovoltaic cell 2C and a third reaction electrode pair 3C. Also in the combination of the third photovoltaic cell 2C and the third reaction electrode pair 3C, a first electrode 11 is electrically connected to a third electrode 41 and a second electrode 21 is electrically connected to a fourth electrode 42, via connecting members 6E, 6F respectively.

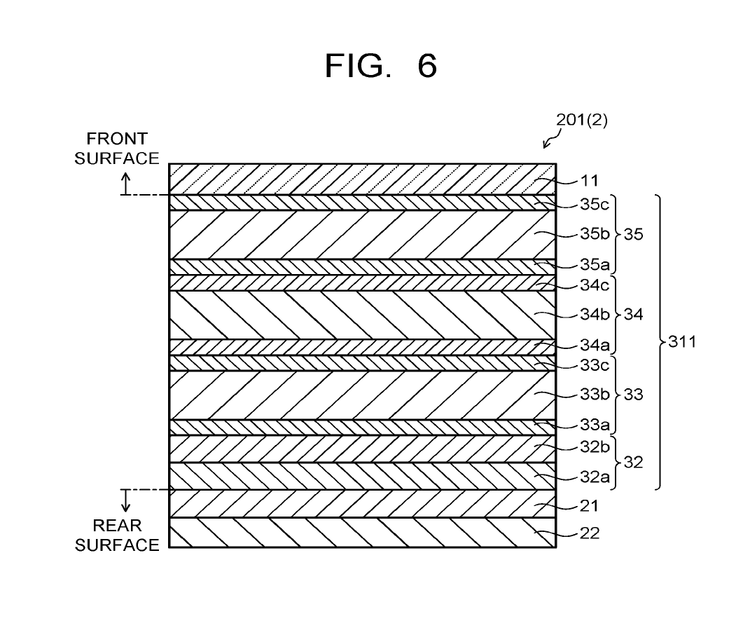

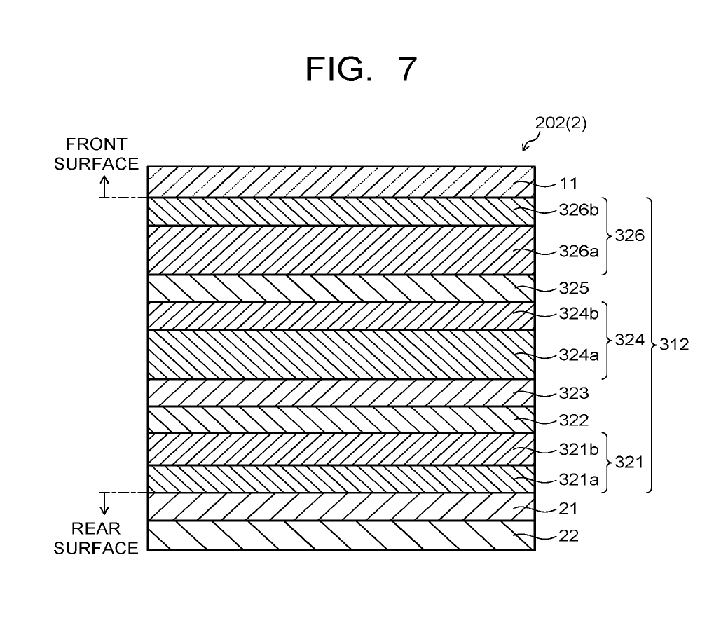

The configuration of the photoelectrochemical reaction device 1 of the first embodiment will be described in detail. The photovoltaic cell 2 has a flat plate shape spreading in a first direction and a second direction perpendicular to the first direction, and is composed of, for example, the second electrode 21 as a substrate, and the photovoltaic layer 31 and the first electrode 11 which are formed in order on the second electrode 21. Here, a description will be given on assumption that a light irradiated side is a front surface (upper surface) and a side opposite the light irradiated side is a rear surface (lower surface). Concrete structural examples of the photovoltaic cell 2 will be described with reference to FIG. 6 and FIG. 7. FIG. 6 illustrates a photovoltaic cell (photoelectrochemical cell) 201 which uses a silicon-based solar cell as a photovoltaic layer 311. FIG. 7 illustrates a photovoltaic cell (photoelectrochemical cell) 202 which uses a compound semiconductor-based solar cell as a photovoltaic layer 312.

In the photovoltaic cell 201 illustrated in FIG. 6, a second electrode 21 has electrical conductivity. As a formation material of the second electrode 21, metal such as Cu, Al, Ti, Ni, Fe, or Ag, an alloy such as SUS containing at least one of these metals, conductive resin, a semiconductor such as Si or Ge, or the like is used. The second electrode 21 is formed on a substrate 22 having electrical conductivity, so that mechanical strength of the photovoltaic cell 201 is maintained. The second electrode 21 itself may have a function as a support substrate. In such a case, as the second electrode 21, a metal plate, an alloy plate, a resin plate, a semiconductor substrate, or the like is used. The second electrode 21 may be composed of an ion exchange membrane.

The photovoltaic layer 311 is formed on the second electrode 21. The photovoltaic layer 311 is composed of a reflective layer 32, a first photovoltaic layer 33, a second photovoltaic layer 34, and a third photovoltaic layer 35. The reflective layer 32 is formed on the second electrode 21 and has a first reflective layer 32a and a second reflective layer 32b which are formed in order from a lower side. As the first reflective layer 32a, metal such as Ag, Au, Al, or Cu, an alloy containing at least one of these metals, or the like that has light reflectivity and electrical conductivity is used. The second reflective layer 32b is provided in order to adjust an optical distance to enhance light reflectivity. The second reflective layer 32b is joined to a later-described n-type semiconductor layer of the photovoltaic layer 31 and therefore is preferably formed of a material having a light transmitting property and capable of coming into ohmic contact with the n-type semiconductor layer. As the second reflective layer 32b, a transparent conductive oxide such as ITO (indium tin oxide), zinc oxide (ZnO), FTO (fluorine-doped tin oxide), AZO (aluminum-doped zinc oxide), or ATO (antimony-doped tin oxide) is used.

The first photovoltaic layer 33, the second photovoltaic layer 34, and the third photovoltaic layer 35 are each a solar cell using a pin junction semiconductor and their light absorption wavelengths are different. Stacking them in a planar manner makes it possible for the photovoltaic layer 311 to absorb light in a wide range of wavelength of sunlight, which makes it possible to more efficiently utilize energy of the sunlight. Since the photovoltaic layers 33, 34, 35 are connected in series, it is possible to obtain a high open-circuit voltage.

The first photovoltaic layer 33 is formed on the reflective layer 32 and has an n-type amorphous silicon (a-Si) layer 33a, an intrinsic amorphous silicon germanium (a-SiGe) layer 33b, and a p-type microcrystalline silicon (mc-Si) layer 33c in order from a lower side. The a-SiGe layer 33b is a layer that absorbs light in a long wavelength range of about 700 nm. In the first photovoltaic layer 33, charge separation is caused by energy of the light in the long wavelength range.

The second photovoltaic layer 34 is formed on the first photovoltaic layer 33 and has an n-type a-Si layer 34a, an intrinsic a-SiGe layer 34b, and a p-type mc-Si layer 34c which are formed in order from a lower side. The a-SiGe layer 34b is a layer that absorbs light in an intermediate wavelength range of about 600 nm. In the second photovoltaic layer 34, charge separation is caused by energy of the light in the intermediate wavelength range.

The third photovoltaic layer 35 is formed on the second photovoltaic layer 34 and has an n-type a-Si layer 35a, an intrinsic a-Si layer 35b, and a p-type mc-Si layer 35c which are formed in order from a lower side. The a-Si layer 35b is a layer that absorbs light in a short wavelength range of about 400 nm. In the third photovoltaic layer 35, charge separation is caused by energy of the light in the short wavelength range. In the photovoltaic layer 311, the charge separations are caused by the lights in the respective wavelength ranges. Specifically, holes are separated to a first electrode (anode) 11 side (front surface side) and electrons are separated to a second electrode (cathode) 21 side (rear surface side), so that an electromotive force is generated in the photovoltaic layer 311.

The first electrode 11 is formed on the p-type semiconductor layer (p-type me-Si layer 35c) of the photovoltaic layer 311. The first electrode 11 is preferably formed of a material capable of coming into ohmic contact with the p-type semiconductor layer. As the first electrode 11, metal such as Ag, Au, Al, or Cu, an alloy containing at least one of these metals, a transparent conductive oxide such as ITO, ZnO, FTO, AZO, or ATO, or the like is used. The first electrode 11 may have, for example, a structure in which the metal and the transparent conductive oxide are stacked, a structure in which the metal and other conductive material are compounded, a structure in which the transparent conductive oxide and other conductive material are compounded, or the like.

In the photovoltaic cell (the photoelectrochemical cell using the silicon-based solar cell) 201 illustrated in FIG. 6, irradiating light passes through the first electrode 11 to reach the photovoltaic layer 311. The first electrode 11 disposed on a light irradiated side (upper side in FIG. 6) has a light transmitting property for the irradiating light. The light transmitting property of the first electrode 11 on the light irradiated side is preferably 10% or more of an irradiation amount of the irradiating light, and more preferably 30% or more thereof. The first electrode 11 may have an aperture through which the light is transmitted. An open area ratio in this case is preferably 10% or more, and more preferably 30% or more.

In order to enhance electrical conductivity while maintaining the light transmitting property, a collector electrode made of metal such as Ag, Au, or Cu, or an alloy containing at least one of these metals may be provided on at least part of the first electrode 11 on the light irradiated side. The collector electrode has a shape transmitting the light, and examples of its concrete shape are a liner shape, a lattice shape, a honeycomb shape, and so on. In order to maintain the light transmitting property, an area of the collector electrode is preferably 30% or less of an area of the first electrode 11, and more preferably 10% or less thereof.

In FIG. 6, the photovoltaic layer 311 having the stacked structure of the three photovoltaic layers is described as an example, but the photovoltaic layer 31 is not limited to this. The photovoltaic layer 31 may have a stacked structure of two, or four or more photovoltaic layers. In place of the photovoltaic layer 31 having the stacked structure, a single photovoltaic layer 31 may be used. The photovoltaic layer 31 is not limited to the solar cell using the pin junction semiconductor, but may be a solar cell using a pn-junction semiconductor. A semiconductor layer may be made of a compound semiconductor such as, for example, GaAs, GaInP, AlGaInP, CdTe, or CuInGaSe, not limited to Si or Ge. As the semiconductor layer, any of various forms such as monocrystalline, polycrystalline, and amorphous forms is applicable. The first electrode 11 and the second electrode 21 may be provided on the whole surface of the photovoltaic layer 31 or may be provided on part thereof.

Next, the photovoltaic cell (the photoelectrochemical cell using the compound semiconductor-based solar cell as the photovoltaic layer) 202 illustrated in FIG. 7 will be described. The photovoltaic cell 202 illustrated in FIG. 7 is composed of a first electrode 11, a photovoltaic layer 312, and a second electrode 21. The photovoltaic layer 312 in the photovoltaic cell 202 is composed of a first photovoltaic layer 321, a buffer layer 322, a tunnel layer 323, a second photovoltaic layer 324, a tunnel layer 325, and a third photovoltaic layer 326.

The first photovoltaic layer 321 is formed on the second electrode 21 and has a p-type Ge layer 321a and an n-type Ge layer 321b which are formed in order from a lower side. On the first photovoltaic layer 321 (Ge layer 321b), the buffer layer 322 containing GaInAs and the tunnel layer 323 are formed for the purpose of lattice matching and electrical joining with GaInAs used in the second photovoltaic layer 324.

The second photovoltaic layer 324 is formed on the tunnel layer 323 and has a p-type GaInAs layer 324a and an n-type GaInAs layer 324b which are formed in order from a lower side. On the second photovoltaic layer 324 (GaInAs layer 324b), the tunnel layer 325 containing GaInP is formed for the purpose of lattice matching and electrical joining with GaInP used in the third photovoltaic layer 326. The third photovoltaic layer 326 is formed on the tunnel layer 325 and has a p-type GaInP layer 326a and an n-type GaInP layer 326b which are formed in order from a lower side.

The photovoltaic layer 312 in the photovoltaic cell (the photoelectrochemical cell using the compound semiconductor-based solar cell as the photovoltaic layer) 202 illustrated in FIG. 7 is different in a stacking direction of the p-type and the n-type from the photovoltaic layer 311 in the photovoltaic cell (the photoelectrochemical cell using the silicon semiconductor-based solar cell) 201 illustrated in FIG. 6, and therefore polarities of their electromotive forces are different. Specifically, when the charge separation is caused in the photovoltaic layer 312 by the irradiated light, electrons are separated to the first electrode (cathode) 11 side (front surface side), and holes are separated to the second electrode (anode) 21 side (rear surface side).

The first and second photovoltaic cells 2A, 2B are arranged on the electrolytic bath 4. The photovoltaic cells 2A, 2B are in close contact with the electrolytic bath 4. The photovoltaic cells 2A, 2B may be in close contact with the electrolytic bath 4 via an insulating member. The first photovoltaic cell 2A and the second photovoltaic cell 2B are preferably arranged to be as short as possible in connection distances to the first reaction electrode pair 3A and the second reaction electrode pair 3B respectively, namely, in length of connecting members 6A to 6D. The first photovoltaic cell 2A is preferably arranged to be located above the first reaction electrode pair 3A electrically connected thereto. The second photovoltaic cell 2BA is preferably arranged to be located above the second reaction electrode pair 3B electrically connected thereto.

The reaction electrode pair 3 has the third electrode 41 immersed in the first electrolytic solution 51, and the fourth electrode 42 immersed in the second electrolytic solution 53. The electrodes 41, 42 are formed of a material having electrical conductivity. As each of the electrodes 41, 42, a metal plate of Cu, Al, Au, Ti, Ni, Fe, Co, Ag, Pt, Pd, Zn, In or the like, an alloy plate containing at least one of these metals, a conductive resin plate, a semiconductor substrate of Si or Ge, or the like is used. The third electrode 41 and the fourth electrode 42 are preferably arranged to be opposed to each other for ions to rapidly migrate. The fourth electrode 42 is preferable arranged as close as possible to the third electrode 41. The distance between the electrodes 41 and 42 is preferably 500 mm or less, and more preferably 100 mm or less. To arrange the ion migration layer 55, the distance between the electrodes 41 and 42 is preferably 100 micrometer or more.

The ion migration layer 55 arranged in the electrolytic bath 4 is composed of an ion exchange membrane or the like which allows ions to migrate between the third electrode 41 and the fourth electrode 42 and can separate the first electrolytic solution 51 and the second electrolytic solution 53. As the ion exchange membrane, a cation exchange membrane such as Nafion or Flemion or an anion exchange membrane such as Neosepta or Selemion can be used. Materials other than the above are applicable as the ion migration layer 55, as long as they are materials allowing the ions to migrate between the third electrode 41 and the fourth electrode 42.

The third and fourth electrodes 41, 42 may have fine pores or slits for allowing ions to migrate. The fine pores or slits are provided to cause ions to migrate while maintaining the mechanical strength of the third and fourth electrodes 41, 42. The fine pores or slits only need to have a size enabling the ions to migrate. For example, a lower limit value of a diameter (circle-equivalent diameter) of the fine pores is preferably 0.3 nm or more. The circle-equivalent diameter is defined as ((4×area)/{pi})^{1/2}. The shape of the fine pores is not limited to a circle and may be an ellipse, a triangle, a square, or the like. The fine pores are arranged in a square lattice form, a triangular lattice form, a random form, or the like. The fine pores or slits may be filled with an ion exchange membrane. The fine pores or slits may be filled with a glass filter or agar.

Though the state in which the third electrode 41 and the fourth electrode 42 are individually arranged in the electrolytic bath 4 is illustrated in FIG. 1 to FIG. 3, but the configuration of the reaction electrode pair 3 is not limited to this. The reaction electrode pair 3 may be a stack in which the third electrode 41 and the fourth electrode 42 are stacked via an ion migration layer. In this case, the ion migration layer is compose of an electrolytic solution filled in a glass filter, agar or the like or an ion exchange membrane. A concrete example of the ion exchange membrane is as described above.

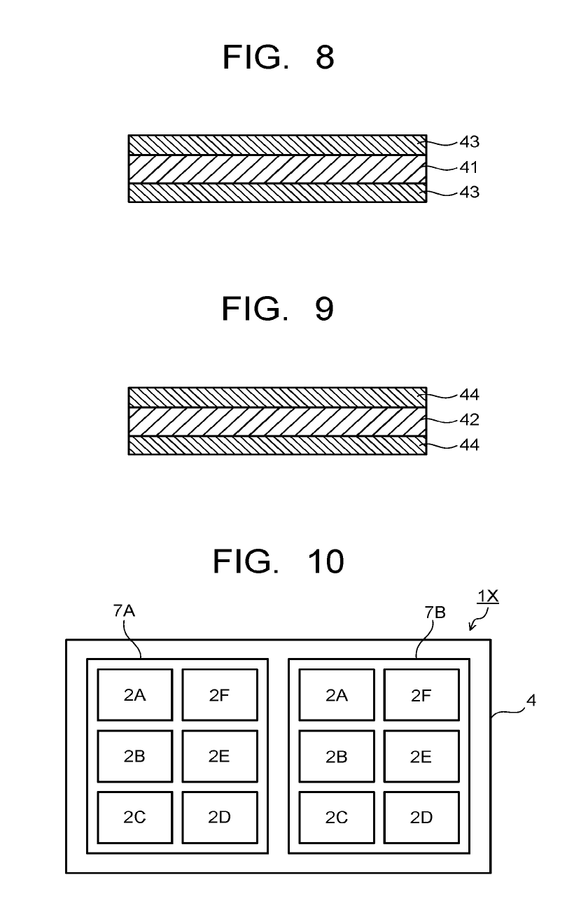

As illustrated in FIG. 8 and FIG. 9, the third electrode 41 may have a first catalyst layer 43, and the fourth electrode 41 may have a second catalyst layer 44. Each of the catalyst layers 43, 44 may be provided on both faces of each of the electrodes 41, 42 as illustrated in FIG. 8 and FIG. 9 or one face thereof. When the photovoltaic cell 201 illustrated in FIG. 6 is used, holes are separated to the first electrode 11 side and electrons are separated to the second electrode 21 side. Accordingly, the oxidation reaction is caused near the third electrode 41, and the reduction reaction is caused near the fourth electrode 42. A catalyst promoting the oxidation reaction is used for the first catalyst layer 43, and a catalyst promoting the reduction reaction is used for the second catalyst layer 44.

When a solution (aqueous solution) containing H₂O is used as the first electrolytic solution 51, the third electrode 41 oxidizes H₂O to generate O₂ and H⁺. Therefore, the first catalyst layer 43 is made of a material which reduces activation energy for oxidizing H₂O. The first catalyst layer 43 is made of a material which lowers an overvoltage when H₂O is oxidized to generate O₂ and H⁺. Examples of such a material are binary metal oxides such as manganese oxide (Mn—O), iridium oxide (Ir—O), nickel oxide (Ni—O), cobalt oxide (Co—O), iron oxide (Fe—O), tin oxide (Sn—O), indium oxide (In—O), and ruthenium oxide (Ru—O), ternary metal oxides such as Ni—Co—O, Ni—Fe—O, La—Co—O, Ni—La—O, and Sr—Fe—O, quaternary metal oxides such as Pb—Ru—Ir—O and La—Sr—Co—O, or metal complexes such as a Ru complex and a Fe complex. A shape of the first catalyst layer 43 is not limited to a thin film shape, and may be an island, a lattice, a granular, or a wire.

When an aqueous solution containing CO₂ is used as the second electrolytic solution 53, the fourth electrode 42 reduces CO₂ to generate a carbon compound (CO, HCOOH, CH₄, CH₃OH, C₂H₅OH, C₂H₄ or the like). Therefore, the second catalyst layer 44 is made of a material which reduces activation energy for reducing CO₂. The second catalyst layer 44 is made of a material which lowers an overvoltage when CO₂ is reduced to generate the carbon compound. Examples of such a material are metals such as Au, Ag, Cu, Pt, Pd, Ni, and Zn, an alloy containing at least one of these metals, carbon materials such as carbon (C), graphene, CNT (carbon nanotube), fullerene, and ketjen black, and metal complexes such as a Ru complex and a Re complex.

When a solution containing H₂O is used as the second electrolytic solution 53, H₂ is sometimes generated by reducing H₂O. In this case, the second catalyst layer 44 is made of a material which reduces activation energy for reducing H₂O. The second catalyst layer 44 is made of a material which lowers an overvoltage when H₂O is reduced to generate H₂. Examples of such a material are metals such as Ni, Fe, Pt, Ti, Au, Ag, Zn, Pd, Ga, Mn, and Cd, an alloy containing at least one of these metals, and carbon materials such as carbon (C), graphene, CNT (carbon nanotube), fullerene, and ketjen black. A shape of the second catalyst layer 44 is not limited to a thin film shape, and may be an island shape, a lattice shape, a granular shape, or a wire shape.

When the photovoltaic cell 202 illustrated in FIG. 7 is used, electrons are separated to the first electrode 11 side, and holes are separated to the second electrode 21 side. Accordingly, an oxidation reaction is caused near the fourth electrode 42, and a reduction reaction is caused near the third electrode 41. The first catalyst layer 43 is made of a material which promotes the reduction reaction, and the second catalyst layer 44 is made of a material which promotes the oxidation reaction. In other words, the material of the first catalyst layer 43 and the material of the second catalyst layer 44 are counterchanged as compared with the case where the photovoltaic cell 201 illustrated in FIG. 6 is used. Thus, the polarity of the photovoltaic layer 31 and the materials of the first catalyst layer 43 and the second catalyst layer 44 are arbitrary. The oxidation and reduction reactions by the first catalyst layer 43 and the second catalyst layer 44 are decided by the polarity of the photovoltaic layer 31, and the materials are selected according to the oxidation and reduction reactions.

As a formation method of the first catalyst layer 43 and the second catalyst layer 44, a thin-film forming method such as a sputtering method or a vapor deposition method, a coating method using a solution in which the catalyst material is dispersed, an electrodeposition method, a catalyst forming method by heat treatment or electrochemical treatment of the third electrode 41 or the fourth electrode 42 itself, or the like is usable. Only one of the first catalyst layer 43 and the second catalyst layer 44 may be formed. The catalyst layers 43, 44 are arbitrarily formed and are formed according to desired oxidation and reduction reactions.

The electrolytic bath 4 includes the first storage part 52 storing the first electrolytic solution 51 and the second storage part 54 storing the second electrolytic solution 53. The third electrode 41 is arranged in the first storage part 52 storing the first electrolytic solution 51. The fourth electrode 42 is arranged in the second storage part 54 storing the second electrolytic solution 53. Of the first and second electrolytic solutions 51, 53, one is a solution containing, for example, H₂O and the other is a solution containing, for example, CO₂. In place of the solution containing CO₂, a solution containing H₂O may be used. When the photovoltaic cell 201 illustrated in FIG. 6 is employed, the solution containing H₂O is used as the first electrolytic solution 51, and the solution containing CO₂ is used as the second electrolytic solution 53. When the photovoltaic cell 202 illustrated in FIG. 7 is employed, the solution containing CO₂ is used as the first electrolytic solution 51, and the solution containing H₂O is used as the second electrolytic solution 53.

As the solution containing H₂O, an aqueous solution containing an arbitrary electrolyte is used. The solution is preferably an aqueous solution that promotes the oxidation reaction of H₂O. Examples of the aqueous solution containing the electrolyte are aqueous solutions containing phosphoric acid ions (PO₄²⁻), boric acid ions (BO₃³⁻), sodium ions (Na⁺), potassium ions (K⁺), calcium ions (Ca²⁺), lithium ions (Li⁺), cesium ions (Cs⁺), magnesium ions (Mg²⁺), chloride ions (Cl⁻), hydrogen carbonate ions (HCO₃⁻), carbonate ions (CO₃²⁻), and so on.

The solution containing CO₂ is preferably a solution having a high CO₂ absorptance. Examples of the solution containing H₂O are LiHCO₃, NaHCO₃, KHCO₃, and CsHCO₃ as aqueous solutions. As the solution containing CO₂, alcohol such as methanol, ethanol, or acetone may be used. The solution containing H₂O and the solution containing CO₂ may be the same solution. Since the solution containing CO₂ is preferably high in a CO₂ absorption amount, a different solution from the solution containing H₂O may be used as the solution containing CO₂. The solution containing CO₂ is desirably an electrolytic solution that reduces a reduction potential of CO₂, has a high ion conductivity, and contains a CO₂ absorbent which absorbs CO₂.

Examples of the aforesaid electrolytic solution are an ionic liquid which is made of salts of cations such as imidazolium ions or pyridinium ions and anions such as BF₄⁻ or PF₆⁻ and which is in a liquid state in a wide temperature range, or aqueous solutions thereof. Other examples of the electrolytic solution are amine solutions of ethanolamine, imidazole, or pyridine, or aqueous solutions thereof. Amine may be any of primary amine, secondary amine, and tertiary amine. Examples of the primary amine are methylamine, ethylamine, propylamine, butylamine, pentylamine, hexylamine, and the like. Hydrocarbons of the amine may be substituted by alcohol, halogen, or the like. Examples of the amine whose hydrocarbons are substituted are methanolamine, ethanolamine, chloromethyl amine, and so on. Further, an unsaturated bond may exist. These hydrocarbons are the same in the secondary amine and the tertiary amine. Examples of the secondary amine are dimethylamine, diethylamine, dipropylamine, dibutylamine, dipentylamine, dihexylamine, dimethanolamine, diethanolamine, dipropanolamine, and so on. The substituted hydrocarbons may be different. This also applies to the tertiary amine. Examples in which the hydrocarbons are different are methylethylamine, methylpropylamine, and so on. Examples of the tertiary amine are trimethylamine, triethylamine, tripropylamine, tributylamine, trihexylamine, trimethanolamine, triethanolamine, tripropanolamine, tributanolamine, triexanolamine, methyldiethylamine, methyldipropylamine, and so on. Examples of the cations of the ionic liquid are 1-ethyl-3-methylimidazolium ions, 1-methyl-3-propylimidazolium ions, 1-butyl-3-methylimidazole ions, 1-methyl-3-pentylimidazolium ions, 1-hexyl-3-methylimidazolium ions, and so on. A second place of imidazolium ions may be substituted. Examples in which the second place of the imidazolium ions is substituted are 1-ethyl-2,3-dimethylimidazolium ions, 1-2-dimethyl-3-propylimidazolium ions, 1-butyl-2,3-dimethylimidazolium ions, 1,2-dimethyl-3-pentylimidazolium ions, 1-hexyl-2,3-dimethylimidazolium ions, and so on. Examples of pyridinium ions are methylpyridinium, ethylpyridinium, propylpyridinium, butylpyridinium, pentylpyridinium, hexylpyridinium, and so on. In both of the imidazolium ions and the pyridinium ions, an alkyl group may be substituted, or an unsaturated bond may exist. Examples of the anions are fluoride ions, chloride ions, bromide ions, iodide ions, BF₄⁻, PF₆⁻, CF₃COO⁻, CF₃SO₃⁻, NO₃⁻, SCN⁻, (CF₃SO₂)₃C⁻, bis(trifluoromethoxysulfonyl)imide, bis(perfluoroethylsulfonyl)imide, and so on. Dipolar ions in which the cations and the anions of the ionic liquid are coupled by hydrocarbons may be used.

Next, an operation principle of the photoelectrochemical reaction device 1 will be described with reference to an electrical connection diagram in FIG. 4. Here, the operation will be described, taking, as an example, the polarity when the photovoltaic cell (the photoelectrochemical cell using the silicon semiconductor-based solar cell as the photovoltaic layer) 201 illustrated in FIG. 6 is used. A case where an absorbing liquid in which CO₂ is absorbed is used as the second electrolytic solution 53 in which the fourth electrode 42 is immersed will be described. Incidentally, when the photovoltaic cell (the photoelectrochemical cell using the compound semiconductor-based solar cell as the photovoltaic layer) 202 illustrated in FIG. 7 is used, the polarity is reversed and therefore, the absorbing liquid in which CO₂ is absorbed is used as the first electrolytic solution 51.

When the light is irradiated from above the first and second photovoltaic cell 2A, 2B, the irradiating light passes through the first electrode 11 to reach the photovoltaic layer 31. When absorbing the light, the photovoltaic layer 31 generates electrons and holes which make pairs with the electrons, and separates them. Specifically, in the first photovoltaic layer 33, the second photovoltaic layer 34, and the third photovoltaic layer 35 which constitute the photovoltaic layer 31, the electrons migrate to the n-type semiconductor layer side (second electrode 21 side) due to a built-in potential, and the holes generated as the pairs with the electrons migrate to the p-type semiconductor layer side (first electrode 11 side), to thereby cause charge separation. Such charge separation generates the electromotive force in the photovoltaic layer 31.

The holes generated in the photovoltaic layer 31 in each of the first and second photovoltaic cells 2A, 2B migrate to the first electrode 11. The holes combine with electrons which are generated by the oxidation reaction caused near the third electrode 41, via the connecting member 6A, 6B and the third electrode 41. The electrons which have migrated to the second electrode 21 are used in the reduction reaction caused near the fourth electrode 42, via the connecting member 6B, 6D and the fourth electrode 42. Concretely, near the third electrode 41 in contact with the first electrolytic solution 51, a reaction of the following formula (1) occurs. Near the second electrode 42 in contact with the second electrolytic solution 53, a reaction of the following formula (2) occurs.

2H₂O→4H⁺+O₂+4e⁻ (1)

2CO₂+4H⁺+4e⁻→2CO+2H₂O (2)

Near the third electrode 41, H₂O contained in the first electrolytic solution 51 is oxidized (loses electrons), so that O₂ and H⁺ are generated, as expressed by the formula (1). H⁺ generated on the third electrode 41 side migrates to the fourth electrode 42 side via the ion migration layer 55. Near the fourth electrode 42, CO₂ contained in the second electrolytic solution 53 is reduced (obtains electrons) as expressed by the formula (2). Concretely, CO₂ contained in the second electrolytic solution 53, H⁺ which has migrated to the fourth electrode 42 from the third electrode 41, and the electrons which have migrated to the fourth electrode 42 react with one another, so that CO and H₂O are generated, for instance.

In this event, the photovoltaic layer 31 needs to have an open-circuit voltage equal to or larger than a potential difference between a standard oxidation-reduction potential of the oxidation reaction occurring near the third electrode 41 and a standard oxidation-reduction potential of the reduction reaction occurring near the fourth electrode 42. For example, the standard oxidation-reduction potential of the oxidation reaction in the formula (1) is 1.23 V, and the standard oxidation-reduction potential of the reduction reaction in the formula (2) is −0.1 V. Therefore, the open-circuit voltage of the photovoltaic layer 31 needs to be 1.33 V or more. The open-circuit voltage of the photovoltaic layer 31 is preferably equal to or more than the potential difference inclusive of overvoltages. Concretely, when the overvoltages of the oxidation reaction in the formula (1) and the reduction reaction in the formula (2) are both 0.2 V, the open-circuit voltage is desirably 1.73 V or more.

Near the fourth electrode 42, it is possible to cause not only the reduction reaction from CO₂ to CO expressed by the formula (2) but also a reduction reaction from CO₂ to formic acid (HCOOH), methane (CH₄), ethylene (C₂H₄), methanol (CH₃OH), ethanol (C₂H₅OH), acetic acid (CH₃COOH) or the like. It is also possible to cause the reduction reaction of H₂O used in the second electrolytic solution 53 to generate H₂. By varying an amount of moisture (H₂O) in the second electrolytic solution 53, it is possible to change a generated reduced substance of CO₂. For example, it is possible to change a generation ratio of CO, HCCOH, CH₄, C₂H₄, CH₃OH, C₂H₅OH, CH₃COOH, H₂, and the like which are generated by the reduction reaction of CO₂.

When generating H₂ near the fourth electrode 42, the reaction of the formula (1) occurs near the third electrode 41, and the reaction of the following formula (3) occurs near the second electrode 42.

2H₂O→4H⁺+O₂+4e⁻ (1)

4H⁺+4e⁻→2H₂ (3)

Near the third electrode 41, H₂O contained in the first electrolytic solution 51 is oxidized (loses electrons), so that O₂ and H⁺ are generated. H⁺ generated on the third electrode 41 side migrates to the fourth electrode 42 side via the ion migration layer 55. Near the fourth electrode 42, H₂ is reduced (obtains electrons) to generate a H₂ gas as expressed by the formula (3).

In the photoelectrochemical reaction device 1 of the first embodiment, electrical connection of the photovoltaic cell 2 and the reaction electrode pair 3 as a set prevents a failure, for example, even when occurring in the first photovoltaic cell 2A, from adversely affecting the combination of the second photovoltaic cell 2B and the second reaction electrode pair 3B. Accordingly, the conversion efficiency from light energy to chemical energy by the second photovoltaic cell 2B and the second reaction electrode pair 3B can be maintained. As a concrete example of the conversion efficiency from light energy to chemical energy, currents flowing through the first reaction electrode pair 3A and the second reaction electrode pair 3B are listed in Table 1. Table 1 lists the currents flowing through the reaction electrode pairs 3A, 3B regarding the case where the first and second photovoltaic cells 2A, 2B normally operate (case 1), the case where the first photovoltaic cell 2A does not generate power (case 2), and the case that the first photovoltaic cell 2A does not generate power and leakage occurs (case 3).

TABLE 1

| | | | TOTAL |
|---|---|---|---|
| | | | CURRENT |
| | | | THROUGH |
| | CURRENT | CURRENT | FIRST |
| | THROUGH | THROUGH | AND |
| | FIRST | SECOND | SECOND |
| | REACTION | REACTION | REACTION |
| | ELECTRODE | ELECTRODE | ELECTRODE |
| | PAIR | PAIR | PAIRS |
| | [mA/cm²] | [mA/cm²] | [mA/cm²] |
| (CASE 1) WHERE | 3.36 | 3.36 | 6.72 |
| FIRST AND | | | |
| SECOND | | | |
| PHOTOVOLATIC | | | |
| CELLS NORMALLY | | | |
| OPERATE | | | |
| (CASE 2) WHERE | 0 | 3.36 | 3.36 |
| FIRST | | | |
| PHOTOVOLATIC | | | |
| CELL DOES NOT | | | |
| GENERATE POWER | | | |
| (CASE 3) WHERE | 0 | 3.36 | 3.36 |
| FIRST | | | |
| PHOTOVOLATIC | | | |
| CELL DOES NOT | | | |
| GENERATE POWER | | | |
| AND LEAKAGE | | | |
| OCCURS | | | |

Since the amount of products by the above-described oxidation and reduction reactions, and the conversion efficiency from sunlight to chemical energy are proportional to the current flowing through the reaction electrode pair 3, a larger current flowing through the reaction electrode pair 3 is more preferable. As listed in Table 1, the currents flowing through the first and second reaction electrode pairs 3A, 3B are at the same level. As listed as the case 2, even in the case where the first photovoltaic cell 2A does not generate power due to cloud or the like, the current flowing through the second reaction electrode pair 3B does not change and is thus not adversely affected by the failure of the first photovoltaic cell 2A. Further, as listed as the case 3, even in the case where leakages occurs in the first photovoltaic cell 2A, the current through the second reaction electrode pair 3B does not change and is thus not adversely affected by the failure of the first photovoltaic cell 2A.

Table 2 lists, as comparative examples of the photoelectrochemical reaction device in the embodiment, currents flowing through the reaction electrode pairs in the case 1, the case 2, and the case 3, as in Table 1, regarding a photoelectrochemical reaction device in which an oxidation reaction electrode pair composed of the third electrode and the fourth electrode is not provided for every photovoltaic cell but two photovoltaic cells connected in parallel are connected to one reaction electrode pair. As indicated in the case 1 in Table 2, when the two photovoltaic cells normally operate, the current flowing through the reaction electrode pair is the same as that in the case 1 of the embodiment. In contrast, as indicated in the case 2 and the case 3 in Table 2, when a failure occurs in one photovoltaic cell, the current flowing through the reaction electrode pair decreases as compared with that of the embodiment even though the other photovoltaic cell normally operates. In particular, when leakage occurs in one photovoltaic cell, the current flowing through the reaction electrode pair greatly decreases.

TABLE 2

| | CURRENT |
|---|---|
| | THROUGH |
| | REACTION |
| | ELECTRODE |
| | PAIR [mA/cm²] |
| (CASE 1) WHERE FIRST AND SECOND | 6.72 |
| PHOTOVOLATIC CELLS NORMALLY | |
| OPERATE | |
| (CASE 2) WHERE FIRST PHOTOVOLATIC | 3.10 |
| CELL DOES NOT GENERATE POWER | |
| (CASE 3) WHERE FIRST PHOTOVOLATIC | 0.67 |
| CELL DOES NOT GENERATE POWER AND | |
| LEAKAGE OCCURS | |

As described above, in the case where a plurality of photovoltaic cells are provided but the reaction electrode pair is not provided for each of the photovoltaic cells, a failed photovoltaic cell affects the other photovoltaic cell, even normally operating, and therefore decreases the current which contribute to oxidation and reduction reactions. Regarding this point, in the photoelectrochemical reaction device 1 in the embodiment, even if a failure occurs in the photovoltaic cell (2A) being a part thereof, its effect is limited only to the operation of the reaction electrode pair (3A) connected to the failed photovoltaic cell (2A) but not to the operations of the other photovoltaic cell (2B) and the reaction electrode pair (3B). Accordingly, an excellent conversion efficiency from light energy to chemical energy can be maintained.

### Second Embodiment

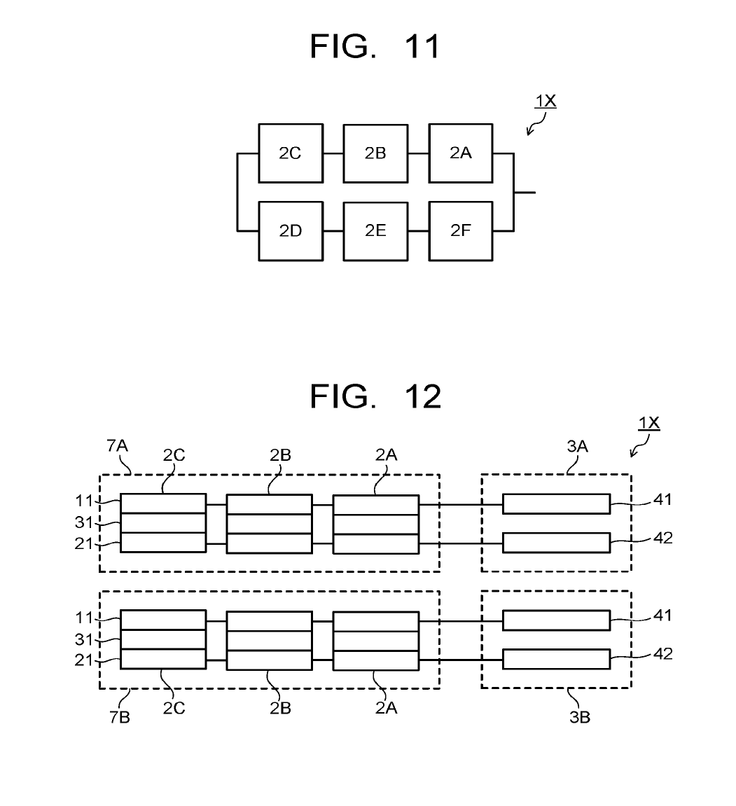

A photoelectrochemical reaction device according to a second embodiment will be described with reference to FIG. 10 to FIG. 12. FIG. 10 is a plan view illustrating the photoelectrochemical reaction device of the second embodiment. FIG. 11 is a view illustrating an electrical connection state of a plurality of photovoltaic cells in a photovoltaic module of the photoelectrochemical reaction device illustrated in FIG. 10. FIG. 12 is a view illustrating an electrical connection state between the plurality of photovoltaic modules in the photoelectrochemical reaction device illustrated in FIG. 10 and reaction electrode pairs. Note that the same parts as those of the photoelectrochemical reaction device of the first embodiment will be denoted by the same reference signs, and a description of part thereof will be sometimes omitted.

A photoelectrochemical reaction device 1X illustrated in FIG. 10 includes a first photovoltaic module 7A, a second photovoltaic module 7B, a first reaction electrode pair 3A, a second reaction electrode pair 3B, and an electrolytic bath 4. Each of the first and second photovoltaic modules 7A, 7B has a plurality of photovoltaic cells 2. In the photoelectrochemical reaction device 1X of the second embodiment, in place of the combinations of the photovoltaic cells 2 and the reaction electrode pairs 3 of the first embodiment, the first photovoltaic module 7A having the plurality of photovoltaic cells 2 and the first reaction electrode pair 3A are combined and are electrically connected, and the second photovoltaic module 7B having the plurality of photovoltaic cells 2 and the second reaction electrode pair 3B are combined and are electrically connected. The other configurations are the same as those in the first embodiment.

Each of the first and second photovoltaic modules 7A, 7B has six photovoltaic cells 2A to 2F. In the six photovoltaic cells 2A to 2F, first electrodes 11 are connected to be three in series and two in parallel, and second electrodes 21 are also connected to be three in series and two in parallel. As illustrated in FIG. 12, the first electrodes 11 connected to be three in series and two in parallel of the first photovoltaic module 7A are electrically connected to the third electrode 41 of the first reaction electrode pair 3A. The second electrodes 21 connected to be three in series and two in parallel are electrically connected to the fourth electrode 42 of the first reaction electrode pair 3A. Similarly, the first electrodes 11 connected to be three in series and two in parallel of the second photovoltaic module 7B are electrically connected to the third electrode 41 of the second reaction electrode pair 3B. The second electrodes 21 connected to be three in series and two in parallel are electrically connected to the fourth electrode 42 of the second reaction electrode pair 3B.

As described above, also in the case where the plurality of photovoltaic modules 7A, 7B are applied, electrical connection of the photovoltaic module 7 and the reaction electrode pair 3 as one set prevents a failed photovoltaic module 7 from adversely affecting the other photovoltaic module 7. Even if a failure occurs in the photovoltaic module (7A) being a part, its effect is limited only to the operation of the reaction electrode pair (3A) connected to the failed photovoltaic module (7A) but not to the operations of the photovoltaic module (7B) and the reaction electrode pair (3B). Accordingly, an excellent conversion efficiency from light energy to chemical energy can be maintained.

### Third Embodiment

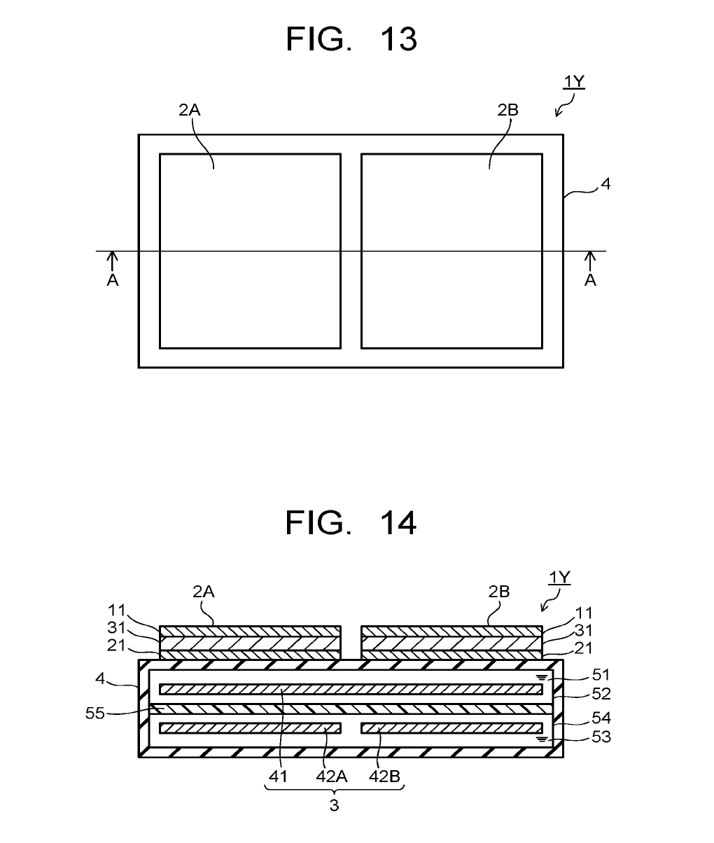

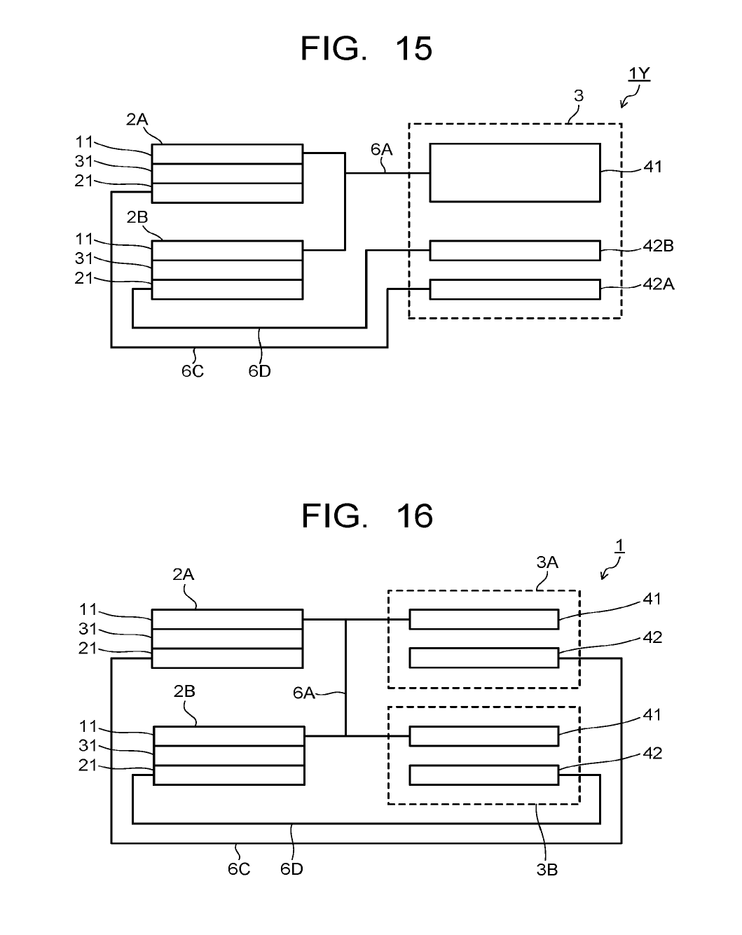

A photoelectrochemical reaction device according to a third embodiment will be described with reference to FIG. 13 to FIG. 15. FIG. 13 is a plan view illustrating the photoelectrochemical reaction device of the third embodiment, FIG. 14 is a cross-sectional view taken along a line A-A in FIG. 13, and FIG. 15 is a view illustrating an electrical connection state of FIG. 13. Note that the same parts as those of the photoelectrochemical reaction device of the first embodiment will be denoted by the same reference signs, and a description of part thereof will be sometimes omitted. A photoelectrochemical reaction device 1Y of the third embodiment includes a first photovoltaic cell 2A, a second photovoltaic cell 2B, a reaction electrode pair 3, and an electrolytic bath 4.

The reaction electrode pair 3 includes a third electrode 41 as a common electrode and two fourth electrodes 42A, 42B as individual electrodes. In a first storage part 52 of the electrolytic bath 4, the third electrode 41 common to the first and second photovoltaic cells, 2A, 2B is arranged. In a second storage part 54 of the electrolytic bath 4, the fourth electrode 42A corresponding to the first photovoltaic cell 2A and the fourth electrode 42B corresponding to the second photovoltaic cell 2B are arranged. The reaction electrode pair 3 includes the third electrode 41 common to the first and second photovoltaic cells 2A, 2B, and the fourth electrode 42A and the fourth electrode 42B individually corresponding to the first and second photovoltaic cells 2A, 2B. The other configurations are the same as those in the first embodiment.

As illustrated in FIG. 15, a first electrode 11 of the first photovoltaic cell 2A and a first electrode 11 of the second photovoltaic cell 2B are electrically connected to the third electrode 41 of the reaction electrode pair 3 via a connecting member 6A. A second electrode 21 of the first photovoltaic cell 2A is electrically to the fourth electrode 42A of the reaction electrode pair 3 via a connecting member 6C. Similarly, a second electrode 21 of the second photovoltaic cell 2B is electrically connected to the fourth electrode 42B of the reaction electrode pair 3 via a connecting member 6D. Here, the third electrode 41 of the reaction electrode pair 3 is the common electrode and the fourth electrode 42 is the individual electrode, but the common electrode and the individual electrode may be reversed. It is only necessary that one of electrodes of the reaction electrode pair 3 is the common electrode and the other of the electrodes is the individual electrode. The number of combinations of the photovoltaic cell 2 and the individual electrode is not limited to two but may be three or more.

As described above, also in the case where the electrode 42 that is one of electrodes of the reaction electrode pair 3 is an individual electrode, electrically connecting the individual electrode 42 and the photovoltaic cell 2 as a set makes it possible to decrease the effect of a failed photovoltaic cell 2 on the other photovoltaic cell 2. Table 3 lists, as in Table 1, currents flowing through the reaction electrode pair in the case 1, the case 2, and the case 3, regarding the third embodiment. It is found that the current flowing through the reaction electrode pair in the third embodiment is larger than that in the comparative example, in any of the case 2 and the case 3. Accordingly, an excellent conversion efficiency from light energy to chemical energy can be maintained. Note that in the case where a plurality of third electrodes 41 and fourth electrodes 42 are provided as illustrated in FIG. 16, when only either of the third electrodes 41 and fourth electrodes 42 are electrically connected in parallel, the same effect as that in the third embodiment can be obtained.

TABLE 3

| | CURRENT |
|---|---|
| | THROUGH |
| | REACTION |
| | ELECTRODE |
| | PAIR [mA/cm²] |
| (CASE 1) WHERE FIRST AND SECOND | 6.72 |
| PHOTOVOLATIC CELLS NORMALLY | |
| OPERATE | |
| (CASE 2) WHERE FIRST PHOTOVOLATIC | 3.83 |
| CELL DOES NOT GENERATE POWER | |
| (CASE 3) WHERE FIRST PHOTOVOLATIC | 3.44 |
| CELL DOES NOT GENERATE POWER AND | |
| LEAKAGE OCCURS | |

### Fourth Embodiment

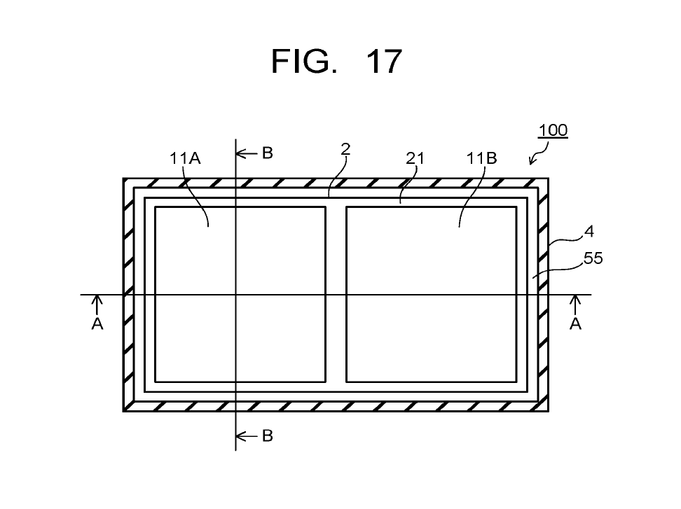

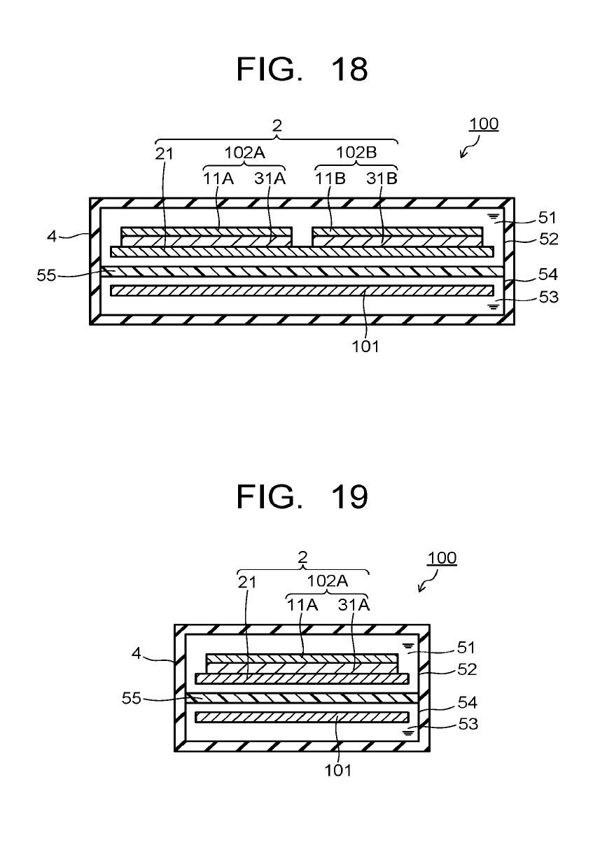

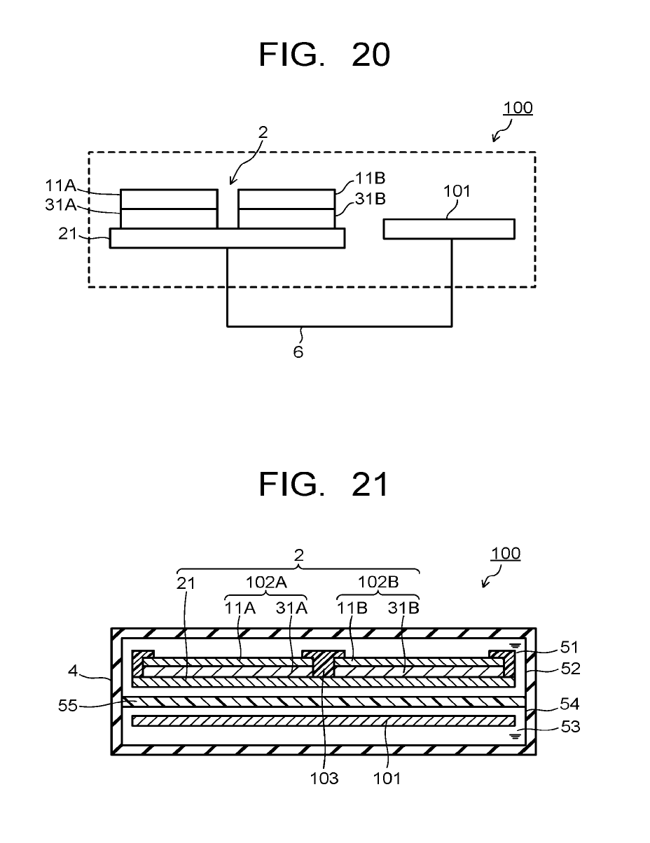

A photoelectrochemical reaction device according to a fourth embodiment will be described with reference to FIG. 17 to FIG. 20. FIG. 17 is a top perspective view illustrating the photoelectrochemical reaction device of the fourth embodiment, FIG. 18 is a cross-sectional view taken along a line A-A in FIG. 17, FIG. 19 is a cross-sectional view taken along a line B-B in FIG. 17, and FIG. 20 is a view illustrating an electrical connection state of FIG. 17. Note that the same parts as those of the photoelectrochemical reaction device of the above-described embodiments will be denoted by the same reference signs, and a description of part thereof will be sometimes omitted.

A photoelectrochemical reaction device 100 according to the fourth embodiment includes a photovoltaic cell 2, a reaction electrode 101, and an electrolytic bath 4. The photovoltaic cell 2 includes two divided first electrodes 11A, 11B, one second electrode 21, a first photovoltaic layer 31A which is provided between one first electrode 11A and the second electrode 21, and a second photovoltaic layer 31B which is provided between the other first electrode 11B and the second electrode 21. Note that concrete configurations and so on of the first electrode 11, the photovoltaic layer 31, the second electrode 21, the electrolytic bath 4 including the electrolytic solutions 51, 53, and the reaction electrode 101 corresponding to the fourth electrode are the same as those in the first embodiment, and their description will be omitted here.

The photovoltaic cell 2 of the fourth embodiment includes the second electrode 21 serving as a common electrode, a first stack unit 102A having the photovoltaic layer 31A and the first electrode 11A stacked in order on the second electrode 21, and a second stack unit 102B having the photovoltaic layer 31B and the first electrode 11B similarly stacked in order on the second electrode 21. The photovoltaic cell 2 is arranged in the electrolytic bath 4. The electrolytic bath 4 includes a first storage part 52 storing the first electrolytic solution 51 in which the photovoltaic cell 2 is immersed, a second storage part 54 storing the second electrolytic solution 53 in which the reaction electrode (corresponding to the fourth electrode) 101 is immersed, and an ion migration layer (an ion migration layer also serving as a separation wall) 55 allowing ions to migrate while separating the first electrolytic solution 51 and the second electrolytic solution 53. The concrete configuration of the ion migration layer 55 is as described above.

As illustrated in FIG. 20, the second electrode 21 of the photovoltaic cell 2 is electrically connected to the reaction electrode 101 immersed in the second electrolytic solution 53 via a connecting member 6. The second electrode 21 does not contribute to oxidation and reduction reactions and therefore may be coated with an insulating member. The second electrode 21 serves as the common electrode with respect to the first stack unit 102A and the second stack unit 102B and is therefore equivalent to being connected in parallel. The first stack unit 102A and the second stack unit 102B are geometrically separated. The thicknesses of the first electrode 11 and the photovoltaic layer 31 are as thin as about 1 micrometer to 10 micrometer, and the solution resistance between the first stack unit 102A and the second stack unit 102B is high. Accordingly, the first stack unit 102A and the second stack unit 102B are equivalent to being electrically insulated. The first electrode 11A of the first stack unit 102A and the first electrode 11B of the second stack unit 102B are equivalent to being not electrically connected. The number of the stack units 102 having the photovoltaic layer 31 and the first electrode 11 is not limited to two but may be three or more.

In the photoelectrochemical reaction device 100 of the fourth embodiment, one of the first electrode 11A, 11B and the reaction electrode 101 causes an oxidation reaction and the other of the first electrode 11A, 11B and the reaction electrode 101 causes a reduction reaction. As in the first embodiment, the first electrodes 11A, 11B and the reaction electrode 101 may have a catalyst layer which promotes the oxidation reaction or the reduction reaction. When light is irradiated to the photovoltaic cell 2, H₂O is oxidized so that O₂ and H⁺ are generated (the formula (1)), for example, near the first electrodes 11A, 11B in contact with the first electrolytic solution 51. H⁺ generated on the first electrodes 11A, 11B side migrates to the reaction electrode 101 side via the ion migration layer 55. Near the reaction electrode 101 in contact with the second electrolytic solution 53, for example, CO₂ is reduced so that CO and H₂O are generated (the formula (2)).

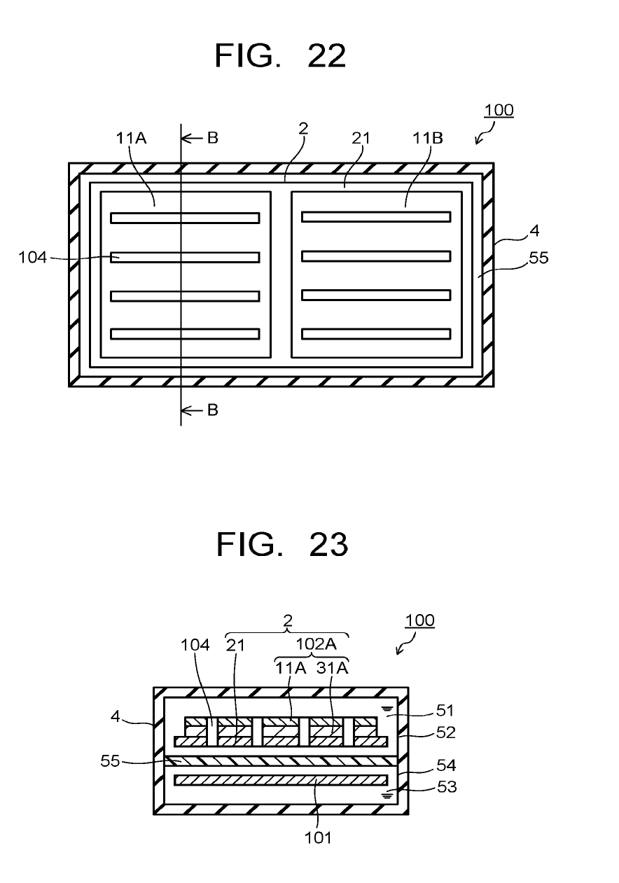

To enhance the insulating property between the first stack unit 102A and the second stack unit 102B, an insulating member 103 may be arranged between them as illustrated in FIG. 21. The insulating member 103 may be provided to cover the peripheries of the first stack unit 102A and the second stack unit 102B. To cause H⁺ ions and the like generated near the first electrodes 11A, 11B to rapidly migrate to the reaction electrode 101 side, the photovoltaic cell 2 may have an ion migration unit 104 such as fine pores or slits as illustrated in FIG. 22 and FIG. 23. The fine pores or slits only need to have a size enabling the ions to migrate. The concrete size is as described above. A shape of the fine pores is not limited to a circle and may be an ellipse, a triangle, a square, or the like. The fine pores are arranged in a square lattice form, a triangular lattice form, a random form, or the like. The fine pores or slits may be filled with an ion exchange membrane. The fine pores or slits may be filled with a glass filter or agar.

The photoelectrochemical reaction device 100 of the fourth embodiment can be recognized as including a first photovoltaic cell based on the first stack unit 102A and a second photovoltaic cell based on the second stack unit 102B, because the second electrode 21 serves as a common electrode. Additionally, the first electrode 11A of the first stack unit 102A and the first electrode 11B of the second stack unit 102B are electrically insulated. Accordingly, as in the third embodiment, a failure, even when occurring in one photovoltaic cell (stack 102), never adversely affects the combination of the other photovoltaic cell (stack 102) and the reaction electrode 101. The conversion efficiency from light energy to chemical energy by the photoelectrochemical reaction device 100 can be maintained.

### Fifth Embodiment

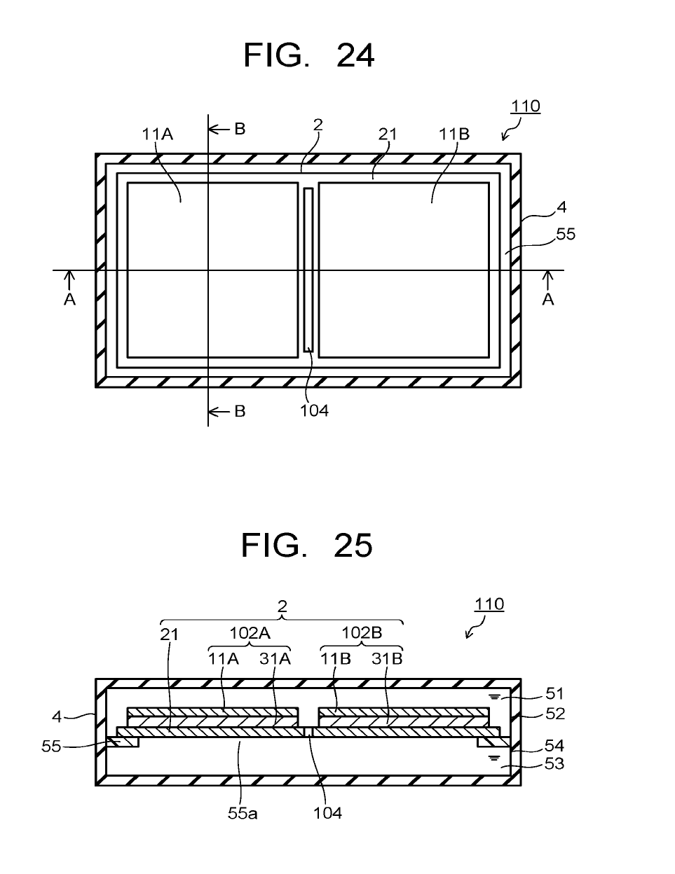

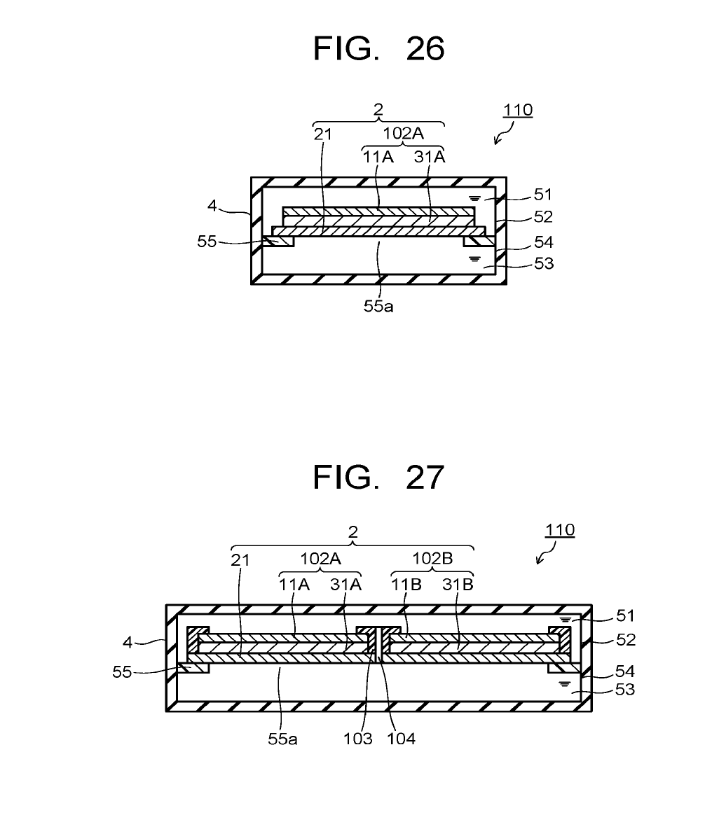

A photoelectrochemical reaction device according to a fifth embodiment will be described with reference to FIG. 24 to FIG. 26. FIG. 24 is a top perspective view illustrating the photoelectrochemical reaction device of the fifth embodiment, FIG. 25 is a cross-sectional view taken along a line A-A in FIG. 24, and FIG. 26 is a cross-sectional view taken along a line B-B in FIG. 24. Note that the same parts as those of the photoelectrochemical reaction devices of the above-described embodiments will be denoted by the same reference signs, and a description of part thereof will be sometimes omitted. A photoelectrochemical reaction device 110 of the fifth embodiment includes a photovoltaic cell 2 and an electrolytic bath 4. The photovoltaic cell 2 includes two divided first electrodes 11A, 11B, one second electrode (common electrode) 21, a first photovoltaic layer 31A provided between one first electrode 11A and the second electrode 21, and a second photovoltaic layer 31B provided between the other first electrode 11B and the second electrode 21.

The photovoltaic cell 2 of the fifth embodiment includes, as in the fourth embodiment, a first stack unit 102A having the photovoltaic layer 31A and the first electrode 11A stacked in order on the second electrode 21, and a second stack unit 102B having the photovoltaic layer 31B and the first electrode 11B stacked in order on the second electrode 21. The photovoltaic cell 2 is arranged in the electrolytic bath 4. The electrolytic bath 4 includes a first storage part 52 storing a first electrolytic solution 51, a second storage part 54 storing a second electrolytic solution 53, and an ion migration layer (an ion migration layer also serving as a separation wall) 55 allowing ions to migrate while separating the first electrolytic solution 51 and the second electrolytic solution 53.

The photovoltaic cell 2 is arranged in the first storage part 52 of the electrolytic bath 4 so that the second electrode 21 is located on the ion migration layer 55. The ion migration layer 55 has an opening 55a for exposing the rear surface of the second electrode 21. The photovoltaic cell 2 is arranged in the first storage part 52, so that the first electrode 11A of the first stack unit 102A and the first electrode 11B of the second stack unit 102B are in contact with the first electrolytic solution 51. The second electrode 21 is in contact with the second electrolytic solution 53 via the opening 55a provided in the ion migration layer 55.

The second electrode 21 serves as the common electrode with respect to the first stack unit 102A and the second stack unit 102B and is thus equivalent to being connected in parallel. The first stack unit 102A and the second stack unit 102B are geometrically separated. The thicknesses of the first electrode 11 and the photovoltaic layer 31 are as thin as about 1 micrometer to 10 micrometer, and the solution resistance between the first stack unit 102A and the second stack unit 102B is high. Accordingly, the first stack unit 102A and the second stack unit 102B are equivalent to being electrically insulated. The number of the stack units 102 having the photovoltaic layer 31 and the first electrode 11 is not limited to two but may be three or more.

In the photoelectrochemical reaction device 100 of the fifth embodiment, one of the first electrode 11A, 11B and the second electrode 21 causes an oxidation reaction and the other of the first electrode 11A, 11B and the second electrode 21 causes a reduction reaction. As in the first embodiment, the first electrodes 11A, 11B and the second electrode 21 may have a catalyst layer which promotes the oxidation reaction or the reduction reaction. When light is irradiated to the photovoltaic cell 2, H₂O is oxidized so that O₂ and H⁺ are generated, for example, near the first electrodes 11A, 11B in contact with the first electrolytic solution 51 as in the fourth embodiment. H⁺ generated on the first electrodes 11A, 11B side migrates to the second electrode 21 side via the ion migration layer 55 or a later-described ion migration unit 104. Near the second electrode 21 in contact with the second electrolytic solution 53, CO₂ is reduced so that CO and H₂O are generated.

To enhance the insulating property between the first stack unit 102A and the second stack unit 102B, an insulating member 103 may be arranged between them as illustrated in FIG. 27. The insulating member 103 may be provided to cover the peripheries of the first stack unit 102A and the second stack unit 102B. To cause H⁺ ions generated near the first electrodes 11A, 11B to rapidly migrate to the second electrode 21 side, the ion migration unit 104 such as fine pores or slits may be provided at a portion of the second electrode 21 located between the first stack unit 102A and the second stack unit 102B. The ion migration unit 104 may be provided to penetrate the first stack unit 102A and the second stack unit 102B. The fine pores or slits only need to have a size enabling the ions to migrate. The concrete size and shape are as described above. The fine pores or slits may be filled with an ion exchange membrane, or may be filled with a glass filter or agar.

The photoelectrochemical reaction device 110 of the fifth embodiment can be recognized as including a first photovoltaic cell based on the first stack unit 102A and a second photovoltaic cell based on the second stack unit 102B, because the second electrode 21 serves as a common electrode. Additionally, the first electrode 11A of the first stack unit 102A and the first electrode 11B of the second stack unit 102B are electrically insulated. As in the fourth embodiment, a failure, even when occurring in one photovoltaic cell (stack 102), never adversely affects the combination of the other photovoltaic cell (stack 102) and the second electrode 21. Accordingly, the conversion efficiency from light energy to chemical energy by the photoelectrochemical reaction device 110 can be maintained.

Note that the configurations of the first to fifth embodiments can be applied in combination. Further, parts thereof can be substituted. While certain embodiments have been described, these embodiments have been presented by way of example only, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A photoelectrochemical reaction device, comprising:
a first photovoltaic cell comprising a first electrode, a second electrode, and a photovoltaic layer provided between the first electrode and the second electrode;
a second photovoltaic cell comprising a first electrode, a second electrode, and a photovoltaic layer provided between the first electrode and the second electrode;
a reaction electrode pair comprising at least one third electrode and two divided fourth electrodes, one of the third and fourth electrodes causing an oxidation reaction, and the other of the third and fourth electrodes causing a reduction reaction;
a first connecting member electrically connecting the first electrodes of the first and second photovoltaic cells to the third electrode of the reaction electrode pair;
a second connecting member electrically connecting the second electrode of the first photovoltaic cell to one of the two fourth electrodes of the reaction electrode pair;
a third connecting member electrically connecting the second electrode of the second photovoltaic cell to the other of the two fourth electrodes of the reaction electrode pair; and
an electrolytic bath storing a first electrolytic solution in which at least the third electrode is immersed and a second electrolytic solution in which at least the fourth electrodes are immersed.

2. The device according to claim 1,
wherein the reaction electrode pair comprises two of the third electrodes which are divided; and
wherein the first connecting member comprises a connecting member which electrically connects the first electrode of the first photovoltaic cell to one of the two third electrodes of the reaction electrode pair, and a connecting member which electrically connects the first electrode of the second photovoltaic cell to the other of the two third electrodes of the reaction electrode pair.

3. The device according to claim 1,
wherein the reaction electrode pair comprises one of the third electrode; and
wherein the first connecting member electrically connects the first electrodes of the first and second photovoltaic cells to the third electrode of the reaction electrode pair.

4. The device according to claim 1,
wherein the electrolytic bath comprises a first storage part which stores the first electrolytic solution, a second storage part which stores the second electrolytic solution, and an ion migration layer which is provided to separate the first electrolytic solution and the second electrolytic solution; and
wherein the first and second photovoltaic cells are arranged outside the electrolytic bath.

5. The device according to claim 1, wherein at least one of the first and second photovoltaic cells comprises a plurality of photovoltaic cells electrically connected.

6. The device according to claim 1, further comprising:
an oxidation catalyst layer provided on one of the third and fourth electrodes; and
a reduction catalyst layer provided on the other of the third and fourth electrodes.

7. The device according to claim 1, wherein one of the third and fourth electrodes oxidizes water to generate oxygen and hydrogen ions, and the other of the third and fourth electrodes reduces carbon dioxide to generate a carbon compound.

8. The device according to claim 1, wherein the photovoltaic layer comprises at least one of a pin-junction semiconductor and a pn-junction semiconductor.

9. A photoelectrochemical reaction device, comprising:
a photovoltaic cell comprising two divided first electrodes, one second electrode, a first photovoltaic layer provided between one of the first electrodes and the second electrode, and a second photovoltaic layer provided between the other of the first electrodes and the second electrode, each of the two first electrodes causing one of an oxidation reaction and a reduction reaction;
a reaction electrode causing the other of the oxidation reaction and the reduction reaction;
a connecting member electrically connecting the second electrode to the reaction electrode; and
an electrolytic bath storing a first electrolytic solution in which the photovoltaic cell is immersed and a second electrolytic solution in which the reaction electrode is immersed.

10. The device according to claim 9, wherein the electrolytic bath comprises an ion migration layer provided between the photovoltaic cell and the reaction electrode.

11. The device according to claim 9, wherein the photovoltaic cell comprises an insulating member arranged to electrically insulate a first stack having one of the first electrodes and the first photovoltaic layer from a second stack having the other of the first electrodes and the second photovoltaic layer.

12. The device according to claim 9, wherein the photovoltaic layer comprises at least one of a pin-junction semiconductor and a pn-junction semiconductor.

13. A photoelectrochemical reaction device, comprising:
a photovoltaic cell comprising two divided first electrodes, one second electrode, a first photovoltaic layer provided between one of the first electrodes and the second electrode, and a second photovoltaic layer provided between the other of the first electrodes and the second electrode, one of the first and second electrodes causing an oxidation reaction and the other of the first and second electrodes causing a reduction reaction; and
an electrolytic bath storing a first electrolytic solution with which the two first electrodes are in contact and a second electrolytic solution with which the second electrode is in contact.

14. The device according to claim 13, wherein the electrolytic bath comprises an ion migration layer provided to separate the first electrolytic solution and the second electrolytic solution.

15. The device according to claim 13, wherein the photovoltaic layer comprises at least one of a pin-junction semiconductor and a pn-junction semiconductor.
